(19) United States
(12) Patent Application Publication
(10) Pub. No.: US 2025/0086755 A1
(43) Pub. Date: Mar. 13, 2025

(54) METHOD AND APPARATUS FOR CAPTURING AN IMAGE OUTSIDE A MOTOR VEHICLE, AND MOTOR VEHICLE

(71) Applicant: Continental Automotive Technologies GmbH, Hannover (DE)

(72) Inventor: Thomas Smits, Straelen (DE)

(73) Assignee: Continental Automotive Technologies GmbH, Hannover (DE)

(21) Appl. No.: 18/882,581

(22) Filed: Sep. 11, 2024

(30) Foreign Application Priority Data
Sep. 12, 2023 (DE) 10 2023 208 846.0

(51) Int. Cl. G06T 5/50; G06V 20/56

(52) U.S. Cl. CPC G06T 5/50; G06V 20/56

(57) ABSTRACT

A method and an apparatus for capturing an image outside a motor vehicle and also a motor vehicle having such an apparatus are disclosed. The disclosure provides for the method to comprise the following steps: capturing an image outside a motor vehicle using a camera device, the captured image being distorted due to the nature of the camera device, capturing a property of the camera device, equalizing the image based on the property of the camera device, providing an overlay image on the image, which overlays at least a portion of the image, providing the equalized image together with the overlay image to a user of the motor vehicle.

### CROSS REFERENCE TO RELATED APPLICATIONS

This U.S. patent application claims the benefit of German patent application No. 10 2023 208 846.0, filed Sep. 12, 2023, which is hereby incorporated by reference.

### TECHNICAL FIELD

The disclosure relates to a method and to an apparatus for capturing an image outside a motor vehicle and also to a motor vehicle having such an apparatus.

### BACKGROUND

Motor vehicles having confusing attachments that protrude into the road and cannot be seen or can be seen only with difficulty from a driver's seat require electronic monitoring using a camera device. However, such monitoring is particularly computationally intensive, especially if it is intended or has to comply with one or more safety standards.

It is therefore an object of the present disclosure to specify an improved method and an improved apparatus for capturing an image outside a motor vehicle.

This object is achieved by means of the subject matter of the independent claims. Advantageous developments are specified in the dependent claims.

### SUMMARY

According to a first aspect, a method for capturing an image outside a motor vehicle is provided.

Here, the method according to the disclosure comprises the steps of capturing an image outside a motor vehicle using a camera device, the captured image being distorted due to the nature of the camera device, capturing a property of the camera device, equalizing the image based on the property of the camera device, providing an overlay image on the image, which overlays at least a portion of the image, and providing the equalized image together with the overlay image to a user of the motor vehicle.

The method according to the disclosure is used in particular to provide a simple and cost-effective possible way of being able to check equalization of a camera image for correctness and functionality.

In particular, embodiments of the method according to the disclosure make it possible to recognize or verify an attachment position of a camera device, in particular its orientation and/or position or coordinate system, in particular with respect to the environment of the camera device, and thereby to determine and correct an erroneous attachment, in particular a tilt, displacement, twisting and/or rotation of the camera and/or a mount of the camera device.

The motor vehicle is in particular a vehicle with oversized external dimensions, such as a transport and/or agricultural vehicle, also comprising in particular attachments and/or equipment, such as a trailer, a bucket, a fork, a trough and/or a mowing apparatus, in particular a rotary mower.

For this purpose, at least one image outside the motor vehicle is captured using a camera device. A camera device is an apparatus which is designed to record one or more, in particular contiguous, images of the exterior of the motor vehicle. In particular, the camera device is designed to continuously and/or periodically record images of the exterior, for example in a video or video stream.

For this purpose, the camera device, which can also be referred to as a camera or image capture device, may be arranged or fastened in particular on or near an outer side of the motor vehicle. In this case, the camera device may both be arranged permanently or in a stationary manner on the motor vehicle and be designed to be releasable or removable.

For example, the camera may be positionable or arrangeable in one or more fastening devices such as mounts or receptacles on the outer side of the motor vehicle, in particular on or near an attachment of the motor vehicle and thus as warranted or required.

The camera device is in particular a camera with a special lens or a special objective which generates a non-proportional image, such as a so-called wide-angle and/or fisheye lens, which may have an opening or image angle of at least 180°, 200°, 220°, 240°, 260°, 280° or more. This means that the image captured by the camera device is distorted and/or misrepresented, in particular misrepresented in a manner curved and/or barrel-shaped and/or fish-eye-shaped at least in sections.

In a further step, at least one property of the camera device is captured.

A property may also be referred to as the context of the camera device and characterizes or defines one or more parameters of the camera device, such as type or nature, location and/or capturable image section or angle of the camera or the lens used, as will be described below. In particular, the property comprises an indication or an assignment to a type and/or severity of a distortion of the recorded image and/or an orientation, tilt, displacement, twisting and/or rotation of the camera device.

The property may be captured here in particular by way of communication of the camera device with a control device, which in particular carries out this and the steps of the method described below and can also cause or trigger the capture of one or more images by the camera device.

For example, the camera may provide its own parameters and in particular those of the installed lens to the control device. In addition, suitable sensors can detect a location of the camera, such as short-range sensors, in particular NFC and/or RFID sensors, which are installed on or in a mount and communicate with the control device.

Alternatively or additionally, a code arranged in or on the mount or near the latter, such as a barcode or QR code, may also be read by the camera device, which allows an indication of the location of the camera device. In this case, the camera device and the control device can communicate with one another both in a wired manner and wirelessly and may provide the properties of the camera device.

Likewise, the property may also be captured by the camera device or the control device itself, for example because the image or the captured image section is analyzed and thus conclusions on a position and/or an attachment location of the camera device are drawn.

In this case, the step of capturing the property may be carried out before, during or after capturing the image(s). In particular, this step is carried out initially, i.e. before the first image is captured by the camera device.

Optionally, an image section may be selected from the captured image, which image section comprises only a partial area or a partial quantity of the captured image, for example a certain opening angle, in particular a certain horizontal and/or vertical opening angle of the total possible opening angle. For example, only a horizontal opening angle of 30° and a vertical opening angle of 20° are selected. This may be done, for example, by cutting and/or cropping. The image section may also be selected here in particular on the basis of the property of the camera device.

The image or the image section is equalized based on the captured property of the camera device.

In this case, the image captured and distorted due to the camera property is equalized, specifically in particular in such a way that a previously distorted or misrepresented image, in particular a strongly barrel-distorted image and/or an image distorted in a fisheye-shaped manner, as captured by the camera device, is imaged onto an undistorted or misrepresentation-free image, in particular a gnomonic, rectilinear, orthographic and/or angle-accurate image. To do this, image processing algorithms are used to edit, arrange and organize the picture elements or pixels in such a way that an equalized image is created.

How exactly the distorted image is equalized may be done in particular by the control device accessing a database in which one or more instructions for equalization based on the respective camera property are stored. For example, predefined equalization routines or instructions are stored in this database for a plurality of camera types, lens types and/or attachment locations, on the basis of which the image may then be equalized.

In this case, the database may be arranged or stored both on or in the camera device and on or in the control device. Alternatively or additionally, the database may also be stored on a remote computing unit, from which it may be retrieved wirelessly if required.

Optionally, after the property of the camera has been identified, it may be provided to a user, in particular a driver, of the motor vehicle, in particular for verification of the captured property. This may be provided, for example, on an output device such as a display device, for example a monitor or display, which is arranged in particular in the interior of the motor vehicle and is visible from a driver's seat during operation of the motor vehicle. Together with the property of the camera, a property of an attachment, which appears at least partially in the captured image, may also be provided.

An overlay image, which overlays at least a portion of the image, is provided on the image.

An overlay image is an image which is substantially at most the same size and/or substantially has at most the same dimensions as the equalized image or the equalized image section, and which overlaps and/or covers at least a portion of the image, which may in particular be predefined. In this case, the overlay image may be at least partially transparent, in particular in sections, for example 25%, 50% or 75% transparent.

The overlay image may in particular be colored, in one or more of the colors red, blue, green or yellow, in particular one or more signal colors, for example with a high color saturation and/or a high contrast, in particular with respect to the colors present in the equalized image.

The overlay image may in particular include geometric shapes, such as one or more line elements and/or surface elements, such as squares, rectangles, trapezoids, triangles, ellipses, circles and/or polygons that are highlighted, in particular in terms of color, by the overlay image in regions corresponding to the equalized image. The overlay image may also include a captured property of the camera and/or an attachment.

In particular, the overlay image is an overlay image corresponding to the at least one camera property. For example, predefined overlay images for a plurality of camera types, lens types and/or attachment locations are stored in a database, from which the correspondingly suitable one may then be selected.

In this embodiment, the overlay image is in particular an image that is not distorted, but corresponds to the equalized image.

The equalized image or the equalized image section together with the overlay image is provided to a user of the motor vehicle.

Thus, the equalized image, overlaid with the overlay image, is output to a user. The output may be provided here, for example, on an output device, as described above.

The solution according to the disclosure makes it possible to provide the user of a motor vehicle with a simple and fast possible way of verifying an equalization process or algorithm.

According to an alternative aspect, a method for capturing an image outside a motor vehicle is provided.

Here, the method according to the disclosure comprises the steps of capturing an image outside a motor vehicle using a camera device, the captured image being distorted due to the nature of the camera device, capturing a property of the camera device, providing a distorted overlay image on the image based on the property, which overlays at least a portion of the image, equalizing the image and the overlay image based on the property of the camera device, and providing the equalized image together with the overlay image to a user of the motor vehicle.

This method is also used in particular to provide a simple and cost-effective possible way of being able to check equalization of a camera image for correctness and functionality. It therefore has the same purpose or solves the same task as mentioned above.

According to this embodiment, at least one image outside of a motor vehicle is also detected by means of a camera device, the captured image being distorted due to the nature of the camera device, and at least one property of the camera device is captured, both essentially as described above in connection with the first embodiment. An image section can also be optionally formed.

In contrast to the first embodiment, however, according to this embodiment, an overlay image that overlays at least a portion of the image is provided on the image, wherein the overlay image is pre-distorted based on the property.

This pre-distorted overlay image is also an image which is substantially at most the same size and/or substantially has at most the same dimensions as the distorted image or the distorted image section, and which overlaps and/or covers at least a portion of the distorted image, which may in particular be predefined. In this case, this pre-distorted overlay image also may in particular be at least partially transparent, in particular in sections, for example 25%, 50% or 75% transparent.

The pre-distorted overlay image may also be colored, in one or more of the colors red, blue, green or yellow, in particular one or more signal colors, for example with a high color saturation and/or a high contrast, in particular with respect to the colors present in the equalized image.

The pre-distorted overlay image may also include geometric shapes, such as one or more line elements, in particular straight or uncurved, for example, diagonals, which in particular follow a fixed point or point to it, and/or surface elements, such as squares, rectangles, trapezoids, triangles, ellipses, circles and/or polygons that are highlighted, in particular in terms of color, by the overlay image in regions corresponding to the equalized image.

The pre-distorted overlay image is also an overlay image corresponding to the at least one camera property, which is stored, for example, in a database with predefined overlay images for multiple camera types, lens types and/or attachment locations, from which the correspondingly suitable image may then be selected.

In particular, the distorted overlay image is not, however, first pre-distorted during the execution of the method, but has been, for example, previously distorted, in particular by a secured, certified and/or tested distortion algorithm based on predefined criteria and in particular for various camera properties and stored in a database to which the control device has access.

The image or image section and the overlay image are then equalized based on the property of the camera device.

The distorted image from the camera device and the overlay image on top of it are thus equalized jointly with each other, in particular in such a way that the previously distorted or misrepresented image, in particular the strongly barrel-distorted image and/or the image distorted in a fisheye-shaped manner, as captured by the camera device, is imaged together with the likewise distorted overlay image onto an undistorted or misrepresentation-free image, in particular a gnomonic, rectilinear, orthographic and/or angle-accurate image. To do this, image processing algorithms are used to edit, arrange and organize the picture elements or pixels in such a way that an equalized image with an overlay image is created.

The equalized image or equalized image section together with the equalized overlay image is provided to a user of the motor vehicle.

Thus, as an alternative to the first described embodiment according to this aspect, a pre-distorted overlay image according to the camera property is first placed on the image captured by the camera device and then the images are equalized together.

Both embodiments provide a cost-effective and rapid possible way of allowing the equalization of a camera image to be checked for correctness and functionality.

All developments described below are applicable to both the first embodiment and the second embodiment.

According to one development, the method further comprises the steps of capturing a user input in response to the equalized image, and enabling a function of the motor vehicle depending on the user input.

The user, in particular the driver, of the motor vehicle thus has the possibility to make an entry in response to the display of the equalized image with the (equalized) overlay image. In particular, the image with the overlay image may be provided together with an input prompt.

In this case, the user may be requested in particular to compare the overlay image with the equalized image or features thereof and, based on the comparison, verify or disconfirm whether the equalization process of the distorted image has been carried out properly.

If the user verifies the image provided, then a function of the motor vehicle may optionally be enabled. However, if the user disconfirms the image provided, a function of the motor vehicle cannot be enabled, blocked or restricted. In particular, this may also be done together with information provided about the restricted function.

Alternatively, it may also be the case that no input prompt and/or user input is made, but the user may freely decide whether the displayed equalized image is correct and based on this, make a positive or negative assessment as to the functional status and/or put a function and/or the motor vehicle into operation or not.

For example, a request to the user may also be provided in response, in which the user is requested to check the camera device, to change its spatial or local position and/or to restart the control device or an initialization process.

The function may be in particular a function of the motor vehicle that is performed by an element which is at least partially arranged in the field of view or the image section, which reproduces the image of the camera device.

In particular, the function is a function with respect to an attachment and/or an item of equipment, such as a trailer, a bucket, a fork, a trough and/or a mowing apparatus, and in particular such an element which is arranged on the motor vehicle in such a way that it cannot be seen or viewed or at least not completely seen or viewed from the driver's seat.

For example, it is a bucket, fork, trough or mowing apparatus that protrudes far ahead of the motor vehicle and protrudes into the intersecting road, especially at narrower intersections and/or intersections that are difficult to see.

Again, for example, it is a trailer whose rear end, especially when reversing, cannot be overlooked by the driver to such an extent that he can safely start or continue a journey.

This function may then be blocked if the user or driver falsifies the provided image with his user input, i.e. does not enable it. For example, actuation of the attachment may be restricted or prevented, or forward and/or reverse travel, i.e. a start of travel as such, may be prevented or only allowed at a restricted speed, for example walking speed, in particular less than 30 km/h, 10 km/h, 5 km/h or 3 km/h.

This development makes it possible that particularly computationally intensive processes, which in particular concern the equalization of the image, can be carried out on a computing unit that does not meet or only partially meets one or more security standards, for example, ASIL, in particular ASIL-A and/or B. In particular, the enable given by the driver allows the safety and in particular the correctness of the equalization process to be verified retrospectively and thus secured.

According to one development, the camera property comprises a model of the camera device.

A model of the camera device comprises in particular a property, type and/or nature of one or more components of the camera device, in particular of the sensor and/or the objective or the lens, such as a manufacturer, type, production model and/or period.

In particular, the model of the camera device comprises a focal length and/or an opening angle of the objective or the lens.

The model of the camera device may also comprise data or information about the housing and/or a fastening device of the camera device, in particular data from a simulation and/or production, for example so-called CAD data, i.e. data derived from a computer-aided design and substantially corresponding to the actual values and, in particular, dimensions of the camera device and/or the fastening device.

In particular, the model also comprises a resolution, a format, an aspect ratio and/or a possible image section of the sensor.

This development makes it possible to carry out the equalization particularly precisely.

According to one development, the overlay image follows a characteristic contour in the image.

A characteristic contour in the image is in particular a line and/or edge of a component of the motor vehicle, such as a body part, in particular a fender, a hood, a rear cover, a pillar, in particular an A-, B- and/or C-pillar, and/or a roof, which has a clear line.

In this case, at least one line and/or one area in the overlay image follows at least one, in particular a plurality of, characteristic contours in the image. In particular, a line in the overlay image coincides with and/or corresponds to a line in the image and/or an area in the overlay image coincides with and/or corresponds to an area in the overlay image. In particular, the overlay image is formed in such a way that it follows or coincides with one or more of these characteristic contours with a tolerance of less than 5 pixels, 3 pixels, 2 pixels, 1 pixel and/or with pixel exactness or pixel accuracy.

This development makes it particularly easy for a user to check the image.

According to one development, the overlay image comprises a rectangular frame.

A rectangular frame means in particular a contour at or near the outer dimensions of the image, in particular a contour outside which less than 10%, 5%, 2%, 1% or no further image information of the image or image section is present and/or outside which fewer than 20 pixels, 10 pixels, 5 pixels, 2 pixels, 1 pixels or no pixels of the overall image are present. In particular, it is the outermost pixel(s) of the image or image section that are overlaid by the overlay image.

In this case, the rectangular frame is contained in particular in the overlay image in the equalized or undistorted state. In other words, in the pre-distorted overlay image the frame is also pre-distorted and thus does not have a rectangular shape, which, however, is then produced by the equalization process.

This makes it possible in particular to check the manner and/or the functional status of the equalization process. In the case of a not fully functional equalization step of the distorted image together with the pre-distorted overlay image including pre-distorted frame, this frame would then also not be displayed as completely rectangular and/or would not be recognizable as a frame.

The use of a frame is also useful for the application of a non-pre-distorted overlay image, as this means the correct image section may also be checked.

This development makes it particularly easy for a user to check the image.

According to one development, the method further comprises the step of calculating a histogram of the image, wherein the overlay image is provided based on the histogram.

A histogram can also be referred to as a brightness and/or intensity profile and determines the corresponding values, in particular average values, of brightness and/or intensity of the respective pixels in the image for the image of the camera device-whether it be distorted or already equalized.

The overlay image can thus be adjusted in color and/or with respect to contrast and/or intensity. For example, with a predominantly dark image of the camera device, a predominantly bright overlay image can be used and vice versa. In particular, alpha-blending may be used for this purpose.

This development makes it particularly easy for a user to check the image.

For carrying out the described steps, it is possible to provide a processor circuit having programming or software comprising program instructions which causes the processor circuit to perform an embodiment of the method when executing the program instructions. The processor circuit may have at least one microprocessor and/or microcontroller for this purpose. The program instructions may be stored in a data memory of the processor circuit.

According to a further aspect, an apparatus is specified which is designed to perform one of the previously described embodiments of the method according to the disclosure.

Here, the apparatus may comprise and/or have access to one or more camera devices. The apparatus may also comprise a control device and a processor circuit, as already described above.

According to a further aspect, a motor vehicle having such an apparatus is specified.

The disclosure also includes developments of the apparatus according to the disclosure and of the motor vehicle according to the disclosure which have features such as have already been described in connection with the developments of the method according to the disclosure. For this reason, the corresponding developments of the apparatus according to the disclosure and the motor vehicle according to the disclosure are not described again here.

For use cases or application situations that may arise in the method and are not explicitly described here, provision may be made for an error message and/or a request for input of user feedback to be output according to the method and/or for a default setting and/or a predetermined initial state to be set.

The invention also includes the combinations of the features of the embodiments described.

### BRIEF DESCRIPTION OF THE DRAWINGS

An embodiment of the disclosure is described below. In this respect:

FIG. 1 shows a schematic plan view of an embodiment of an apparatus for capturing an image outside a motor vehicle and a motor vehicle;

FIG. 2 shows a detailed view from FIG. 1;

FIG. 3 shows a result of an embodiment of a method for capturing an image outside a motor vehicle;

FIG. 4 shows a result of a further embodiment of a method for capturing an image outside a motor vehicle;

FIG. 5 shows a result of a further embodiment of a method for capturing an image outside a motor vehicle;

FIG. 6 shows a schematic flowchart of an embodiment of an apparatus and a method for capturing an image outside a motor vehicle; and

FIG. 7 shows a schematic flowchart of an alternative embodiment of an apparatus and a method for capturing an image outside a motor vehicle.

### DETAILED DESCRIPTION

The exemplary embodiment explained below is a preferred embodiment of the disclosure. In the exemplary embodiment, the described components of the embodiment each represent individual features of the disclosure that should be considered independently of one another and that each also develop the disclosure independently of one another and may therefore also be considered to be part of the disclosure individually or in a combination other than that shown. Furthermore, the embodiment described may also be supplemented by further features of the disclosure that have already been described.

In the figures, elements with the same function are each provided with the same reference signs.

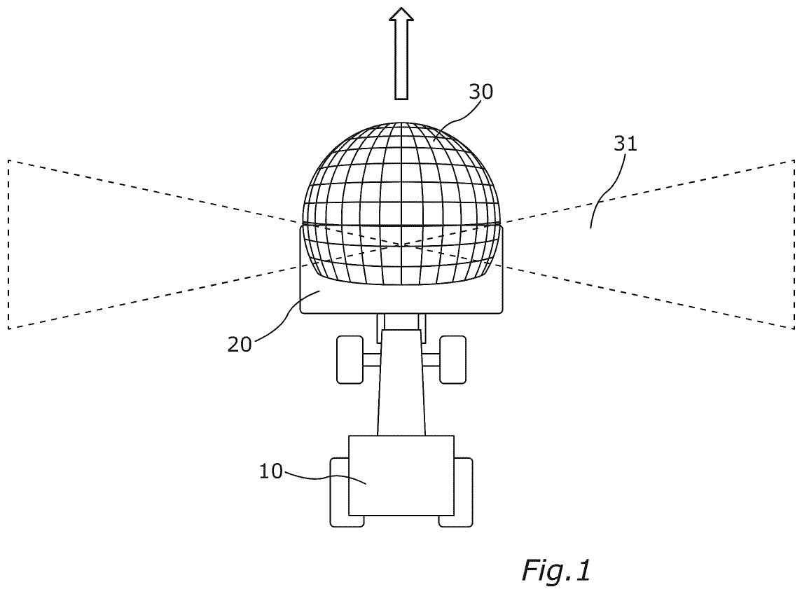

FIG. 1 shows a schematic plan view of an embodiment of an apparatus for capturing an image outside a motor vehicle and a motor vehicle 10.

The motor vehicle 10 moves along a direction of travel, which is indicated by an arrow, and comprises an attachment 20 or an attachment apparatus which is shown here by way of example as a mowing apparatus. The attachment or the attachment apparatus is, by way of example here, a front attachment or a front attachment apparatus.

The motor vehicle 10 also comprises a camera device which is not shown in this FIG. 1 for reasons of clarity. Here, this camera device captures a capture area 30 which is almost spherical and has a capture angle-both horizontally and vertically—of 220°.

In this embodiment shown, the sections indicated by reference sign “31” are relevant here in particular, since they capture an important part of the attachment 20. Here, these sections are still spherically distorted due to the capture area or angle of the camera device.

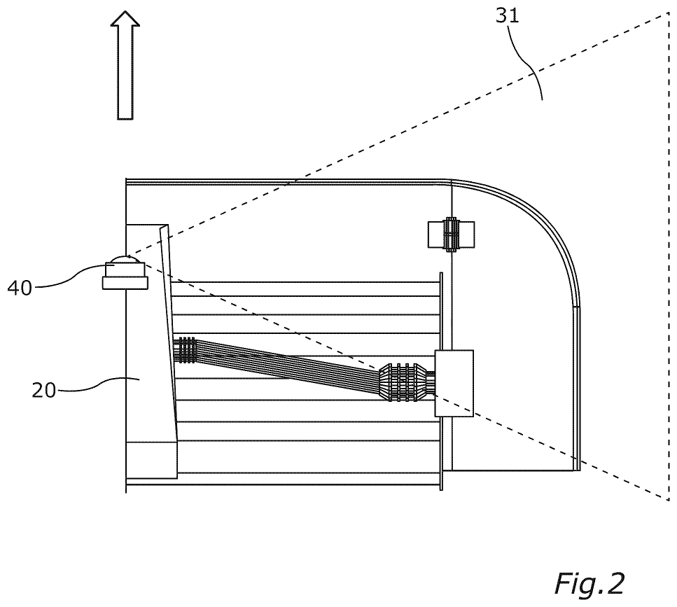

FIG. 2 shows a detailed view from FIG. 1.

In this FIG. 2, the camera device 40 is shown here by way of example with a fisheye lens which captures a right-hand part of the attachment in a section 31.

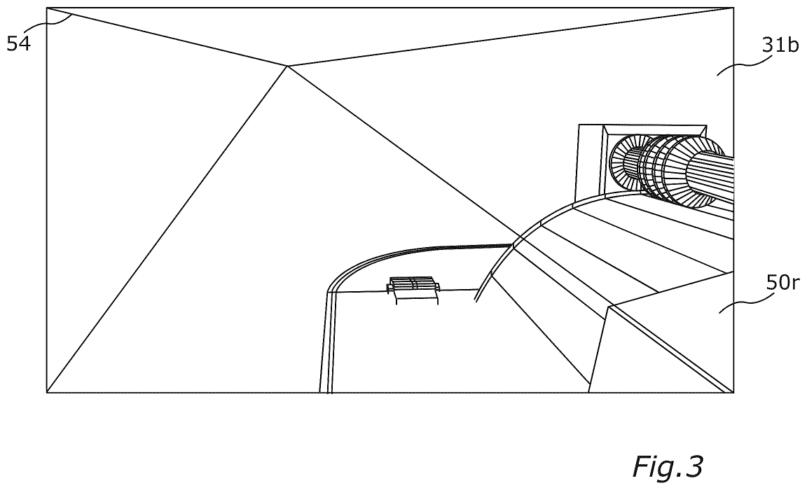

FIG. 3 shows a result of an embodiment of a method for capturing an image outside a motor vehicle 10.

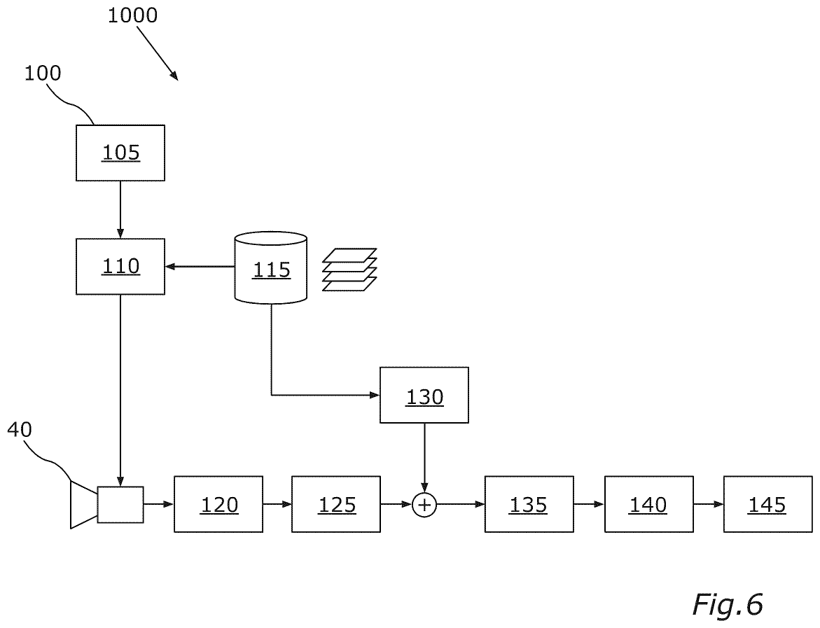

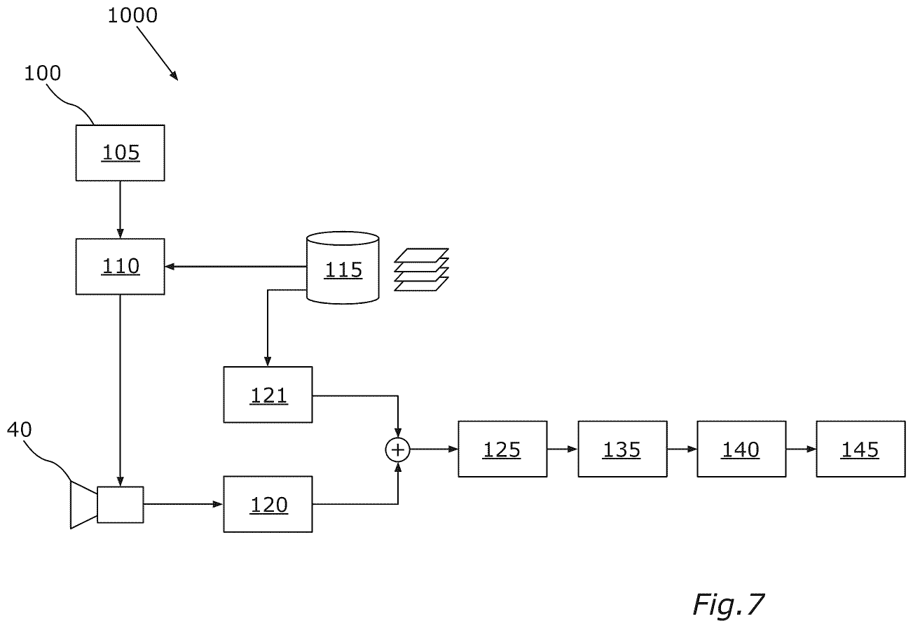

In this case, the image section 31 from FIG. 2 was equalized into an equalized image section 31b and displayed together with an overlay image 54 in an image with overlay image 50r. In this case, the overlay image 54 may be provided both in equalized form overlaid with the equalized image section 31b, as well as in pre-distorted form on the distorted image section and equalized together with it, as will be explained in more detail in connection with FIGS. 6 and 7.

The overlay image is shown here by way of example in such a way that it comprises multiple lines or diagonals, which are directed at a fixed point and follow a characteristic contour of the motor vehicle.

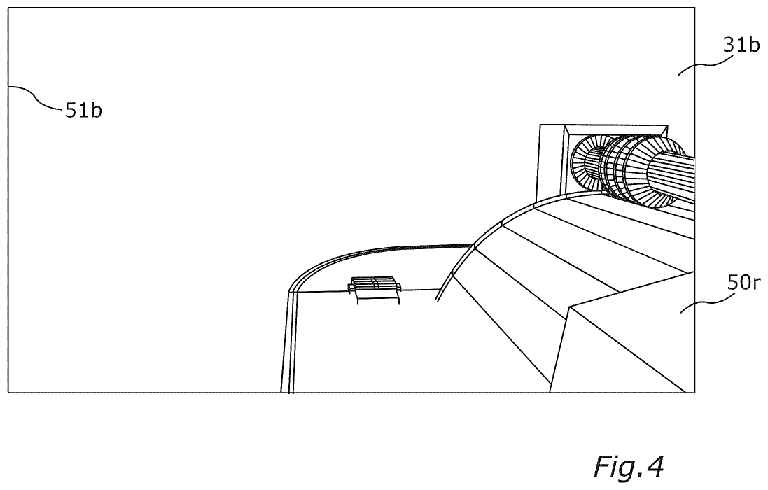

FIG. 4 shows a result of a further embodiment of a method for capturing an image outside a motor vehicle.

In this case, as an alternative to the embodiment shown in FIG. 3, the overlay image 51b is illustrated in such a way that it is a rectangular frame.

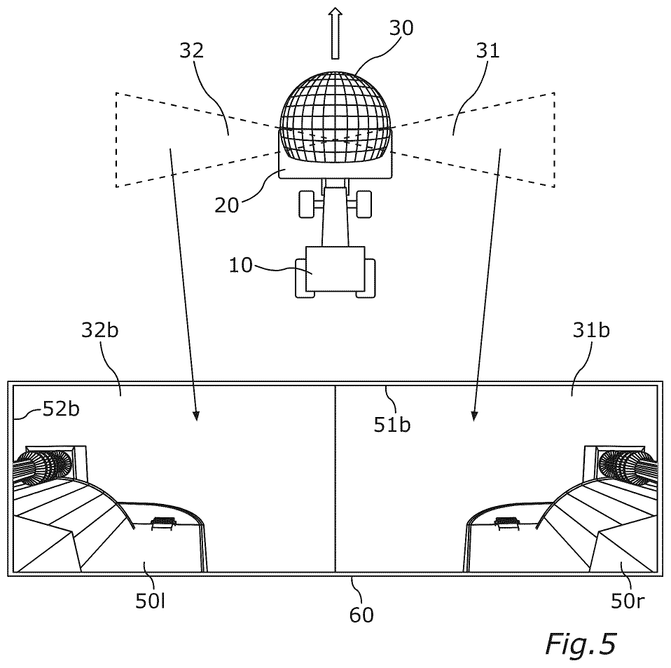

FIG. 5 shows a result of a further embodiment of a method for capturing an image outside a motor vehicle.

This shows once again how the right section 31 and the left section 32 are equalized into an equalized image section 31b and 32b and superimposed with an overlay image 51b and 52b in the form of a rectangular frame, in order to be provided side by side in a left image with overlay image 501 and a right image with overlay image 50r on a display device 60 for a user, not shown, of the motor vehicle.

FIG. 6 shows a schematic flowchart of an embodiment of an apparatus 1000 and a method 100 for capturing an image outside a motor vehicle.

Here, the apparatus 1000 carries out the method described below or its steps.

The method 100 according to the disclosure begins with step 105, in which one or more properties or a context of a camera device 40 is/are determined.

In a further step 110, the camera device 40 is configured based on the determined properties. This is effected by accessing a memory or a database 115 in which information about the camera device 40 is stored.

One or more images or a video comprising a plurality of consecutive images of the exterior of the motor vehicle is/are then captured using the camera device 40 in step 120. Here, the images are distorted due to the property of the camera device.

The captured image is then equalized in step 125 using a suitable image equalization algorithm and based on the camera properties.

Based on the determined properties of the camera device 40, a non-pre-distorted overlay image is retrieved from the database 115 in step 130.

This overlay image is merged with the captured image of the camera device and a combined image is generated so that at least a part of the captured and equalized image is overlaid by the overlay image.

In step 135, the equalized image is displayed together with the overlay image on a display device to a user of the motor vehicle.

In step 140, a user input with respect to the provided image is captured with the overlay image and in step 145, in response to the user input, a function of the motor vehicle is enabled or blocked depending on the user input.

FIG. 7 shows a schematic flowchart of an alternative embodiment of an apparatus 1000 and a method 100 for capturing an image outside a motor vehicle.

This embodiment differs from the embodiment shown in FIG. 6 in particular in that a pre-distorted overlay image is provided on the distorted image and both of these are then equalized together, as will be described below.

The method 100 according to the invention begins with step 105, in which one or more properties or a context of a camera device 40 is/are determined.

In a further step 110, the camera device 40 is configured based on the determined properties. This is effected by accessing a memory or a database 115 in which information about the camera device 40 is stored.

An image or a video comprising a plurality of consecutive images of the exterior of the motor vehicle is then captured using the camera device 40 in step 120. Here, the images are distorted due to the property of the camera device.

Based on the determined properties of the camera device 40, in step 121 a pre-distorted overlay image is retrieved from the database 115 and merged with the captured image of the camera device, so that at least a part of the captured and equalized image is overlaid by the overlay image.

Then, in step 125, equalization of the captured image is performed together with the overlay image using a suitable image equalization algorithm and based on the camera properties in order to produce an equalized overlaid image, which is provided in step 135.

In step 135, the equalized image is displayed together with the overlay image on a display device to a user of the motor vehicle.

In step 140, a user input with respect to the provided image is captured with the overlay image and in step 145, in response to the user input, a function of the motor vehicle is enabled or blocked depending on the user input.

Overall, the example shows how a method for the cost-effective implementation of functionally safe operation of a camera device on a motor vehicle may be provided.

1. A method for capturing an image outside a motor vehicle, comprising:
capturing an image outside a motor vehicle using a camera device, the captured image being distorted due to the nature of the camera device;
capturing a property of the camera device;
equalizing the image based on the property of the camera device;
providing an overlay image on the image, which overlays at least a portion of the image; and
providing the equalized image together with the overlay image to a user of the motor vehicle.

2. A method for capturing an image outside a motor vehicle, comprising:
capturing an image outside a motor vehicle using a camera device, the captured image being distorted due to the nature of the camera device;
capturing a property of the camera device;
providing a distorted overlay image on the image based on the property, which overlays at least a portion of the image;
equalizing the image and the overlay image based on the property of the camera device; and
providing the equalized image together with the equalized overlay image to a user of the motor vehicle.

3. The method as claimed in claim 1, further comprising:
capturing a user input in response to the equalized image; and
enabling a function of the motor vehicle depending on the user input.

4. The method as claimed in claim 1, wherein the camera property comprises a model of the camera device.

5. The method as claimed in claim 1, wherein the overlay image follows a characteristic contour in the image.

6. The method as claimed in claim 1, wherein the overlay image comprises a rectangular frame.

7. The method as claimed in claim 1, further comprising:
calculating a histogram of the image, wherein the overlay image is provided based on the histogram.

8. An apparatus for capturing an image outside a motor vehicle, wherein the apparatus is designed to carry out a method, the method comprising:
capturing an image outside a motor vehicle using a camera device, the captured image being distorted due to the nature of the camera device;
capturing a property of the camera device;
equalizing the image based on the property of the camera device;
providing an overlay image on the image, which overlays at least a portion of the image; and
providing the equalized image together with the overlay image to a user of the motor vehicle.

9. A motor vehicle comprising an apparatus for capturing an image outside a motor vehicle, wherein the apparatus is designed to carry out a method, the method comprising:
capturing an image outside a motor vehicle using a camera device, the captured image being distorted due to the nature of the camera device;
capturing a property of the camera device;
equalizing the image based on the property of the camera device;
providing an overlay image on the image, which overlays at least a portion of the image; and
providing the equalized image together with the overlay image to a user of the motor vehicle.
